(19) United States
(12) Patent Application Publication
(10) Pub. No.: US 2025/0206885 A1
(43) Pub. Date: Jun. 26, 2025

(54) Organopolysiloxane Depolymerization

(71) Applicants: ELKEM SILICONES France SAS, Lyon (FR); Université Claude Bernard Lyon 1, Villeurbanne (FR); Centre national de la recherche scientifique, Paris (FR); ECOLE SUP CHIMIE PHYS ELECTRONIQ LYON (CPE LYON), Villeurbanne (FR)

(72) Inventors: Aurélie BOULEGUE MONDIERE, Millery (FR); Nicolas DURAND, Ternay (FR); Duc-Nam VU, Lyon (FR); Jean RAYNAUD, Villeurbanne (FR); Vincent MONTEIL, Lyon (FR)

(21) Appl. No.: 18/848,761

(22) PCT Filed: Mar. 21, 2023
(86) PCT No.: PCT/EP2023/057124

§ 371 Date: Sep. 19, 2024

(30) Foreign Application Priority Data
Mar. 22, 2022 (FR) 22 02507
Dec. 26, 2022 (FR) 22 14489

(51) Int. Cl. C08G 77/10; C08G 77/04; C08G 77/08; C08J 11/16

(52) U.S. Cl. CPC C08G 77/10; C08G 77/045; C08G 77/08; C08J 11/16; C08J 2383/04

(57) ABSTRACT

The present invention relates to a process for preparing cyclic polysiloxane by reactive distillation of at least one organopolysiloxane in the presence of an alkaline salt catalyst selected from salts of K, Na, Rb or Cs, and a multidentate complexing agent.

The present invention relates to cyclic organopolysiloxanes and more particularly to an organopolysiloxane preparation method for preparing cyclic organopolysiloxanes by depolymerization of organopolysiloxanes in the presence of a catalytic system comprising an alkaline catalyst and a multidentate complexing agent.

The recycling of industrial products and used silicone products is an ongoing issue of concern. The recycling of silicone polymer could enable a 75% reduction in gas emissions (CO, CO2) associated with the silicone industry and a 65% reduction in silicone waste.

One of the recycling routes envisaged is the depolymerization of organopolysiloxanes to produce cyclic organopolysiloxanes (or cyclosiloxane).

The depolymerization of silanol-terminated polydimethylsiloxane (PDMS) in the presence of strong alkali hydroxide or quaternary hydroxide is already known, in particular from U.S. Pat. No. 5,670,689. The reaction is carried out at 140° C. in order to achieve a 90% yield of a mixture of cyclic organopolysiloxanes. However, a high load of catalyst is required, in particular at least 2% by weight relative to the weight of PDMS-OH.

There is therefore an interest in providing an optimised process that enables organopolysiloxane to be depolymerised efficiently and to obtain a good yield of cyclic siloxanes, in particular D3 (hexamethylcyclotrisiloxane), D4 (octamethylcyclotetrasiloxane) and D5 (decamethylcyclopentasiloxane).

One objective of the present patent application is therefore to provide a depolymerization process for the depolymerization of organopolysiloxane in an efficient manner which makes it possible to obtain a good yield of cyclic organopolysiloxanes, in particular D3, D4 and D5.

Another objective of the present application is to provide a catalytic system for implementing this process.

Yet another objective of the present application is to provide a catalytic system that is simple and provides for good reaction kinetics thus being compatible with the industrialisation of the process.

Other objectives will become apparent upon reading the description of the invention that follows below.

These objectives are achieved in the present patent application, which relates to a method for preparing cyclic organopolysiloxane CO by reactive distillation of at least one organopolysiloxane O in the presence of an alkali salt type catalyst selected from the salts of K, Na, Rb or Cs, and of a multidentate complexing agent.

The organopolysiloxane O of the invention may be any type of organopolysiloxane, in particular selected from linear organopolysiloxanes, for example oils, or gums, or branched organopolysiloxanes.

The organopolysiloxane O may in particular be an oil or a gum, and preferably has a dynamic viscosity of between 50 and 600,000 mPa·s at 25° C. or a consistency of between 200 and 2000 expressed in tenths of a millimetre at 25° C.

All the viscosities referred to in the present description correspond to a so-called ‘Newtonian’ dynamic viscosity value at 25° C., i.e. the dynamic viscosity which is measured, in a manner known per se, with a Brookfield viscometer at a shear rate gradient which is sufficiently low for the measured viscosity to be independent of the rate gradient.

The term ‘gum’ is used for organopolysiloxane compounds having viscosities typically greater than 600,000 mPa·s, which corresponds to a molecular weight greater than 260,000 g/mol.

The consistency or penetrability of a gum is determined at 25° C. using a penetrometer of the type PNR12 or an equivalent model which enables a cylindrical head to be applied to the sample under standardised conditions.

These organopolysiloxanes O may comprise one or more functional units such as:
OH;
H;
alkenyl, in particular containing from 2 to 6 carbon atoms, preferably vinyl;
O-Alk with Alk representing an alkyl group containing from 1 to 15 carbon atoms, preferably from 1 to 12 carbon atoms, preferably from 1 to 10 carbon atoms, preferably from 1 to 5 carbon atoms, preferably methyl;
(O-Alk)ₓ with Alk representing an alkyl group containing from 1 to 15 carbon atoms, preferably from 1 to 12 carbon atoms, preferably from 1 to 10 carbon atoms, preferably from 1 to 5 carbon atoms, preferably methyl; and x represents an integer between 2 and 200;
amino group, in particular (Alk)-NH₂ or (Alk)-NH—(Alk)-NH₂, with Alk representing an alkyl containing from 1 to 5 carbon atoms;
cyclic amine for example —(CH₂)_{z}—O-piperidine, wherein z represents an integer from 1 to 5, preferably 3; and piperidine may be substituted in particular by one or more alkyl groups containing from 1 to 3 carbon atoms, preferably methyl; preferably the substituted piperidine is a group

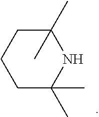

Preferably, the organopolysiloxanes O may comprise one or more functional units such as H, OH, alkenyl (preferably vinyl), aryl, cyclic amine, as defined above.

The organopolysiloxanes O of the invention may be partially cross-linked.

The organopolysiloxanes O of the invention may in particular be waste (used) organopolysiloxanes which have been used, for example, as heat transfer fluids and which ought to be recycled, with the method of the invention thus making it possible to generate cyclic organopolysiloxanes CO that can subsequently be used directly in industrial processes, in particular in new polymerization processes. For example, the organopolysiloxanes O of the invention may be silicone oils in particular terminated with trimethylsilyl, dimethylhydroxysilyl or dimethylvinylsilyl units, or indeed silicone gels. In the event of redeploying waste organopolysiloxanes O, the organopolysiloxane may then contain other elements such as additives, pigments, etc. The inventors have thus shown that the presence of these other elements does not interfere with the depolymerization reaction and the formation of cyclic organopolysiloxanes CO.

According to one embodiment of the invention, the organopolysiloxane O of the invention comprises:
at least 5 units, preferably at least 10 siloxyl units, having the formula R_{c}SiO_{(4-c)/2} wherein
R, which may be identical or different, represents
   an alkyl group containing from 1 to 15 carbon atoms, preferably from 1 to 12 carbon atoms, preferably from 1 to 10 carbon atoms, preferably from 1 to 5 carbon atoms, preferably methyl;
   an aryl group containing from 6 to 10 carbon atoms, preferably phenyl; and c=0, 1, 2 or 3; and
possibly one or more units having the formula R¹_{d}RₑSiO_{(4-d-e)/2}
wherein:
R is as defined above
R¹, which may be identical or different, represents:
   an alkenyl group containing from 2 to 6 carbon atoms, preferably vinyl;
   a hydroxyl group (OH);
   a group (O-Alk) with Alk representing an alkyl group containing from 1 to 15 carbon atoms, preferably from 1 to 12 carbon atoms, preferably from 1 to 10 carbon atoms, preferably from 1 to 5 carbon atoms, preferably OCH₃ or OC₂H₅;
   a group (O-Alk)ₓ with Alk representing an alkyl group containing from 1 to 15 carbon atoms, preferably from 1 to 12 carbon atoms, preferably from 1 to 10 carbon atoms, preferably from 1 to 5 carbon atoms, preferably methyl; and x represents an integer between 2 and 200;
   an amino group selected from (Alk)-NH₂ or (Alk)-NH—(Alk)-NH₂, with Alk representing an alkyl containing from 1 to 5 carbon atoms;
   cyclic amine for example—(CH₂)_{z}—O-piperidine, wherein z represents an integer from 1 to 5, preferably 3, and piperidine may be substituted in particular by one or more alkyl groups containing from 1 to 3 carbon atoms, preferably methyl, preferably the substituted piperidine is a group

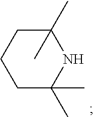

a hydrogen;
d=1, 2 or 3, preferably d=1 or 2, more preferably d=1; e=0, 1 or 2; and the sum d+e=1, 2 or 3.

It is understood in the above formulas that, if multiple R groups are present or if multiple R¹ groups are present, they may be identical to or different from each other.

Preferably, in the above formulas, R¹, which may be identical or different, represents:
an alkenyl group containing from 2 to 6 carbon atoms, preferably vinyl;
a hydroxyl group (OH);
cyclic amine for example—(CH₂)_{z}—O-piperidine, wherein z represents an integer from 1 to 5, preferably 3, and piperidine may be substituted in particular by one or more alkyl groups containing from 1 to 3 carbon atoms, preferably methyl, preferably the substituted piperidine is a group

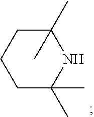

a hydrogen.

In the present invention:
a siloxyl unit “M” represents a siloxyl unit having the formula Y₃SiO_{1/2},
a siloxyl unit “D” represents a siloxyl unit having the formula Y₂SiO_{2/2},
a siloxyl unit “T” represents a siloxyl unit having the formula YSiO_{3/2},
a siloxyl unit “Q” represents a siloxyl unit having the formula SiO_{4/2}, the symbols Y being R or R¹.

The organopolysiloxane O may optionally comprise a small quantity of T and Q units. Without intending to be bound by any particular theory, the depolymerization process of the invention may be implemented on organopolysiloxanes O comprising long chains of successive D units. Preferably the organopolysiloxane O according to the invention comprises less than 20%, preferably less than 10%, even more preferentially less than 5%, and even more preferentially less than 2% of T or Q units as defined above relative to the number of total siloxyl units of the organopolysiloxane O.

According to one preferential embodiment, the organopolysiloxane O of the invention is preferably selected from among the compounds having the formula (I):

R¹ₐR₍₃₋ₐ₎SiO—(SiR₂O)ₙ—(SiR¹RO)ₘ—SiR¹ₐR₍₃₋ₐ₎ (I)
wherein: 20
R which may be identical or different, represents:
   an alkyl group containing from 1 to 15 carbon atoms, preferably from 1 to 12 carbon atoms, preferably from 1 to 10 carbon atoms, preferably from 1 to 5 carbon atoms, preferably methyl;
   an aryl group containing from 6 to 10 carbon atoms, preferably phenyl;
R¹, which may be identical or different, represents:
   an alkenyl group containing from 2 to 6 carbon atoms, preferably vinyl;
   a hydroxyl group (OH);
   a group (O-Alk) with Alk representing an alkyl group containing from 1 to 15 carbon atoms, preferably from 1 to 12 carbon atoms, preferably from 1 to 10 carbon atoms, preferably from 1 to 5 carbon atoms, preferably OCH₃ or OC₂H₅;
   a group (O-Alk)ₓ with Alk representing an alkyl group containing from 1 to 15 carbon atoms, preferably from 1 to 12 carbon atoms, preferably from 1 to 10 carbon atoms, preferably from 1 to 5 carbon atoms, preferably methyl; and x represents an integer between 2 and 200;
   an amino group selected from (Alk)-NH₂ or (Alk)-NH—(Alk)-NH₂, with Alk representing an alkyl containing from 1 to 5 carbon atoms;
   cyclic amine for example—(CH₂)_{z}—O-piperidine, wherein z represents an integer from 1 to 5, preferably 3, and piperidine may be substituted in particular by one or more alkyl groups containing from 1 to 3 carbon atoms, preferably methyl, preferably the substituted piperidine is a group

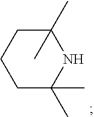

a hydrogen;
a is an integer and represents 0, 1, 2 or 3, preferably 0, 1 or 2, more preferentially 0 or 1;
n represents an integer between 10 and 10,000, preferably between 10 and 5,000, preferably between 50 and 5000, more preferentially between 60 and 5000, for example between 70 and 1000;
m represents an integer between 0 and 100, preferably between 0 and 50, more preferentially between 0 and 30, preferably m=0.

The presence of the group Si—H in the organopolysiloxane O can generate a release of dihydrogen. Therefore, with respect to the device for implementing the method of the invention, in the event of the quantity of the group Si—H being significant, it may be advantageous to provide for a device for managing the release of dihydrogen. In order to avoid having to deploy such a device, the quantity of the group Si—H is preferably less than 20%, preferably less than 10%, more preferably less than 5%, most preferably less than 2% by weight relative to the total weight of organopolysiloxane O.

In a particularly preferred manner, the organopolysiloxane O of the invention is a compound having the formula (I)
wherein R¹, which may be identical or different, represents:
   an alkenyl group containing from 2 to 6 carbon atoms, preferably vinyl;
   a hydroxyl group (OH);
   cyclic amine for example—(CH₂)_{z}—O-piperidine, wherein z represents an integer from 1 to 5, preferably 3, and piperidine may be substituted in particular by one or more alkyl groups containing from 1 to 3 carbon atoms, preferably methyl, preferably the substituted piperidine is a group

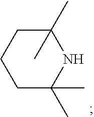

a hydrogen.

In a particularly preferred manner, the organopolysiloxane O of the invention is a compound having the formula (I)
wherein R¹, which may be identical or different, represents CH₃, vinyl, H or OH.

In a particularly preferred manner, the organopolysiloxane O of the invention is a compound having the formula (I)
wherein
R, which may be identical or different, represents CH₃ or phenyl, preferably CH₃;
R¹, which may be identical or different, represents:
   an alkenyl group containing from 2 to 6 carbon atoms, preferably vinyl;
   a hydroxyl group (OH);
   cyclic amine for example —(CH2)_{z}—O-piperidine, wherein z represents an integer from 1 to 5, preferably 3, and piperidine may be substituted in particular by one or more alkyl groups containing from 1 to 3 carbon atoms, preferably methyl, preferably the substituted piperidine is a group

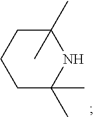

a hydrogen.

In a particularly preferred manner, the organopolysiloxane O of the invention is a compound having the formula (I)
wherein
R, which may be identical or different, represents CH₃ or phenyl, preferably CH₃;
R¹, which may be identical or different, represents CH₃, vinyl, H or OH.

In an advantageous manner, the method of the invention may be implemented with organopolysiloxanes O having a dynamic viscosity of between 3 and 20,000,000 mPa·s, preferably between 3 and 6,000,000 mPa·s, for example between 3 and 1,000,000 mPa·s, at 25° C. In a particularly advantageous manner, the method of the invention may be implemented with an organopolysiloxane O or a mixture of organopolysiloxanes O having a dynamic viscosity, of the organopolysiloxane O or of the mixture of organopolysiloxanes O, of between 3 and 1,000,000 mPa·s, preferably between 100 and 60,000 mPa·s, at 25° C. It should therefore be understood that, in an advantageous manner, in order to facilitate the implementation of the method, in the context of mixtures of organopolysiloxanes, the organopolysiloxane O may have variable viscosities to the extent that the viscosity of the mixture is as mentioned above.

In addition, the method of the invention may be implemented in the presence of a solvent. The solvent should be selected from among solvents that solubilise organopolysiloxane O. The solvent may be an alcohol or n-paraffins. Preferably, the alcohol is selected from among fatty alcohols such as n-lauryl alcohol, n-myristyl alcohol, n-palmitic alcohol, n-stearyl alcohol, n-docosanol, or Guerbet alcohols such as 2-octyl 1-dodecanol, 2-decyl 1-tetradecanol. Preferably the n-paraffins are selected from the compounds C₁₆H₃₄, C₁₈H₃₈, C₂₀H₄₂, C₂₂H₄₆, or C₂₄H₅₀. Where a solvent is deployed in the method of the invention, the quantity of solvent added is preferably between 5 and 50% by weight, preferably between 10 and 20% by weight, relative to the weight of organopolysiloxane O. In a particularly advantageous way, in order to facilitate the implementation of the method, the use of a solvent will serve to facilitate the implementation of the method of the invention with organopolysiloxanes O which are more viscous, for example having a viscosity of between 1,000,000 and 20,000,000 mPa·s at 25° C., such that the mixture (organopolysiloxane O+solvent) has a viscosity of between 3 and 1,000,000 mPa·s, preferably between 100 and 60,000 mPa·s at 25° C.

The alkali salt catalyst is an alkali metal salt comprising a metal M, the metal M being selected from K, Na, Rb or Cs, preferably K, Rb or Cs.

Preferably, the said alkali metal salt is selected from among silanolates, hydroxides, alkoxides and siliconates, preferably silanolates.

In the context of the present invention, where reference is made to the term ‘alkali metal salt’, the below terms are to be understood as follows: ‘silanolate’ is a salt derived from a silanol group which is a functional group comprising at least one Si—OH group. Silanolates generally have the formula MOSi(R′)₃ with M as defined above; and R′, which may be identical or different, represents a linear or branched alkyl group containing from 1 to 6 carbon atoms, or an alkenyl group containing from 2 to 6 carbon atoms; preferably R′, which may be identical or different, represents methyl or vinyl. ‘siliconate’ is a compound having the formula M (OSi(R³)₂)ₚ—OSi(R³)₂ with M as defined above; and R3 represents an alkyl group containing from 1 to 6 carbon atoms, preferably methyl; and p represents an integer between 1 and 20, preferably between 1 and 10. ‘hydroxide’ is a group having the formula MOH, with M as defined above. ‘alkoxide’ is a compound having the formula MOAlk, with M as defined above; and Alk represents a linear or branched alkyl containing from 1 to 22 carbon atoms, preferably from 1 to 15 carbon atoms, more preferably from 1 to 12 carbon atoms.

Preferably, the alkaline catalyst of the invention is a catalyst having the formula M-X wherein
M is selected from K, Na, Rb, Cs, preferably K, Rb, Cs, preferably K; and
X is selected from OSiR⁴₂R⁵, OH, OAlk, with Alk representing a linear or branched alkyl containing from 1 to 22 carbon atoms, preferably from 1 to 15 carbon atoms, preferably from 1 to 12 carbon atoms; (OSi(R³)₂)p-OSi(R³)₂ with M as defined above and R3 represents an alkyl group containing from 1 to 6 carbon atoms, preferably methyl, and p represents an integer between 1 and 20, preferably between 1 and 10; R⁴ which may be identical or different, represents a linear or branched alkyl containing from 1 to 6 carbon atoms, preferably methyl; R⁵ represents a linear or branched alkyl containing from 1 to 6 carbon atoms, preferably methyl, or a vinyl group;
preferably X represents OSiMe₃ (Me represents methyl), OSiMe₂Vi (Vi represents vinyl), OH or O-tBu (tBu represents tert-butyl), OSi(Me)₂—(OSi(Me)₂)ₚ—OSiMe₃ with p as defined above.

Preferably, M is selected from K, Rb, Cs; and X is selected from OSiMe₃, OSiMe₂ Vi (Vi represents vinyl), OH, OSi(Me)₂—(OSi(Me)₂)ₚ—OSiMe₃, where p represents an integer between 1 and 20, preferably between 1 and 10, and O-tBu (tBu represents tert-butyl). Preferably the alkaline catalyst is KOSiMe₃ (Potassium Trimethylsilanolate).

In the context of this patent application the term ‘multidentate complexing agent’ is used to refer to a complexing agent for the alkali metal of the alkali salt catalyst, that is to say a complexing agent for K, Na, Rb or Cs, preferably a complexing agent for K, Rb or Cs.

Preferably, the multidentate complexing agents of the invention are selected from crown ethers, cryptands which are diamine macroheterocycles, and OH- or OCH₃-terminated polyethylene glycols (PEGs), preferably OCH₃-terminated polyethylene glycols, preferably the polyethylene glycols are polyethylene glycol dimethyl ethers. Preferably, the PEGs are soluble in the reaction medium. Consequently, and preferably, the PEGs have a low number average molar mass (Mn), for example between 100 and 2000, preferably between 200 and 1000 g/mol. The number average molar mass (Mn) may be measured by any appropriate technique known to the person skilled in the art, for example by means of steric exclusion chromatography (SEC).

Preferably, the crown ethers contain from 2 to 8 oxygen atoms. The crown ethers are cyclic oligomers of ethylene oxide comprising as the repeating unit a (CH2-CH2-O) group; these crown ethers may be substituted or 2 carbon atoms of a (CH2-CH2-O) unit may be fused with a hydrocarbon ring, in particular cyclohexyl or phenyl.

Preferably, the multidentate complexing agents are selected from:

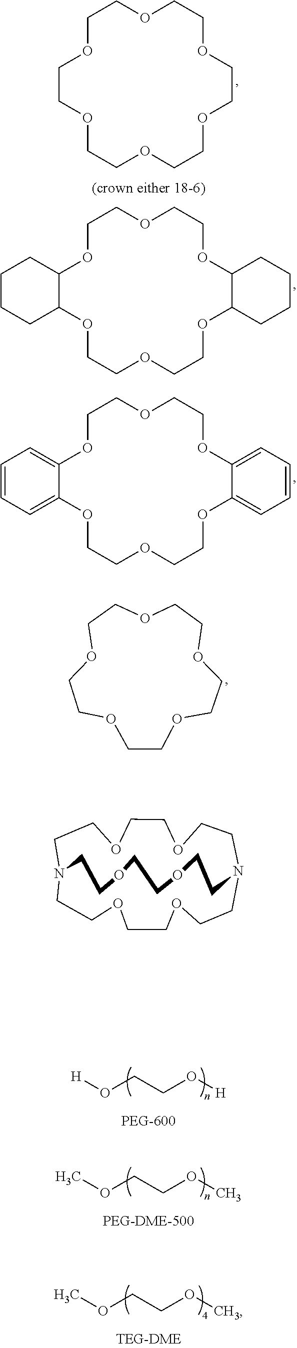

preferably

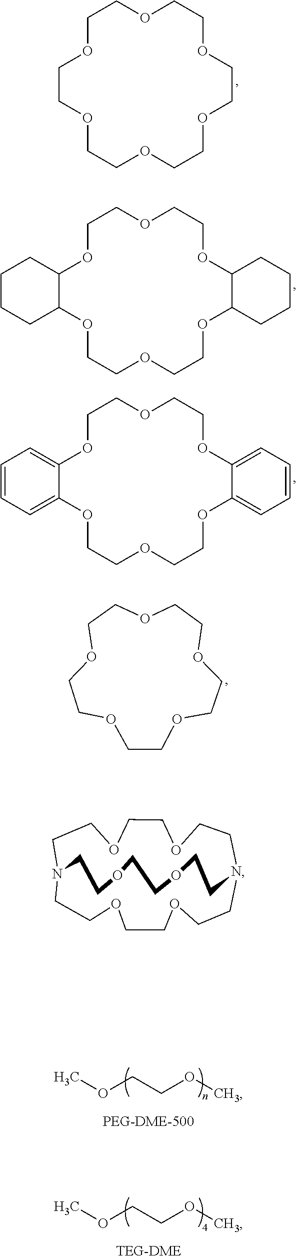

preferably

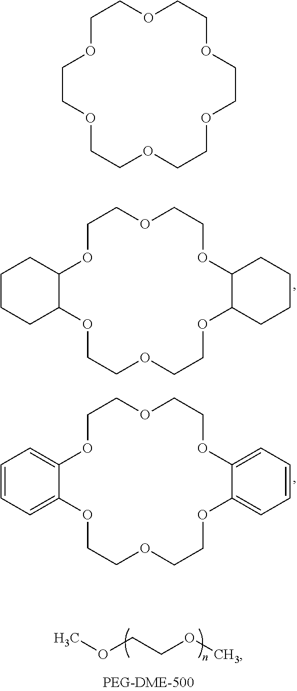

Depending on the alkali metal, and in particular its size, the person skilled in the art would know the multidentate complexing agent that would be appropriate for use.

The alkali salt is used in implementation in catalytic proportions, preferably in an amount of between 0.005 and 1.5% by weight relative to the weight of organopolysiloxane (O), preferably between 0.005 and 0.9%, more preferentially between 0.01 and 0.8%.

Preferably, in the context of the present invention, the alkali salt/multidentate complexing agent molar ratio is between 1/100 and 100/1, preferably between 1/50 and 50/1, more preferably between 1/25 and 25/1, more preferably between 1/10 and 10/1, more preferably between 1/4 and 4/1, preferably between 1/2 and 2/1, preferably greater than or equal to 1, preferably between 1 and 2, for example the ratio is equal to 1.

The method of the invention is implemented at a temperature of between 5° and 200° C., preferably between 6° and 180° C., more preferably between 12° and 160° C.

The method of the invention operationally implements a reactive distillation process.

As is known to the person skilled in the art, reactive distillation consists of combining a separation by distillation and a chemical reaction. The device for implementing the reactive distillation therefore combines a reactor and a distillation system.

The reactive distillation, and the method of the invention, may be implemented based on a continuous or discontinuous—ie batch—process.

Batch reactive distillation combines the advantages of reactive distillation and of the batch (discontinuous) process. The reaction mixture is loaded into the reactor and the reaction products are distilled off as they are produced.

In the case of implementation in continuous mode, the reagents are introduced in a continuous manner.

In one embodiment, the method of the invention, and the reactive distillation, are implemented in a continuous manner. Preferably, the temperature is between 5° and 200° C., preferably between 6° and 180° C., more preferably between 12° and 160° C. Preferably, the pressure is between 0.01 and 50 mbar, preferably between 0.1 and 35 mbar, more preferentially between 5 and 30 mbar.

A person skilled in the art would also know how to adapt the pair of pressure and temperature settings. For example, in one embodiment the pressure is between 0.01 and 50 mbar for a temperature of between 5° and 200° C., preferably the pressure is between 5 and 30 mbar for a temperature of between 12° and 160° C.

In another embodiment, the method of the invention, and the reactive distillation, are implemented in batch mode. Preferably, the temperature is between 5° and 200° C., preferably between 6° and 180° C., more preferably between 12° and 160° C. Preferably, the pressure is between 0.01 and 50 mbar, preferably between 0.1 and 35 mbar, more preferentially between 5 and 30 mbar.

In this embodiment, the reaction and heating begin at atmospheric pressure and then after a period of 10 to 120 min, preferably 30 to 60 min, after the temperature has been reached, the reactive distillation begins at a pressure of between 0.01 and 50 mbar, preferably between 0.1 and 35 mbar, more preferentially between 5 and 30 mbar.

The method of the present invention may be implemented either with or without the presence of a solvent, in particular of the alcohol type. Preferably, the alcohol is selected from fatty alcohols such as n-lauryl alcohol, n-myristyl alcohol, n-palmitic alcohol, n-stearyl alcohol, n-docosanol, or Guerbet alcohols such as 2-octyl 1-dodecanol, 2-decyl 1-tetradecanol. The solvent may also be selected from the group of n-paraffins such as the compounds C₁₆H₃₄, C₁₈H₃₈, C₂₀H₄₂, C₂₂H₄₆, C₂₄H₅₀. Where a solvent is deployed in the method of the invention, the quantity of solvent added is preferably between 5 and 50% by weight, preferably between 10 and 20% by weight, relative to the weight of organopolysiloxane.

The cyclic organopolysiloxanes CO (or cyclic organopolysiloxanes) obtained by the method of the invention are preferably the compounds D3, D4 or D5. Preferably, the cyclic organopolysiloxanes CO obtained are obtained as a mixture comprising more than 95% by weight of a mixture of the compounds D3, D4 or D5, preferably from 95 to 99%, relative to the total weight of cyclic organopolysiloxanes CO produced.

Preferably the predominant compound obtained by the method of the invention is the compound D4. Preferably, the method of the invention makes it possible to obtain a yield of D4 of at least 80% by weight.

The compounds D3, D4 and D5 are preferably compounds having the following formulae:

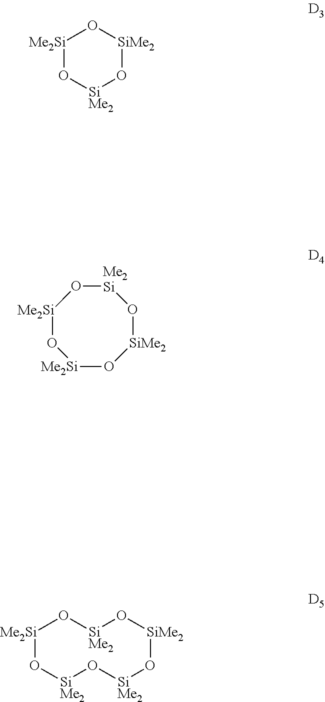

As mentioned above, the starting organopolysiloxane O may include functional groups described by the group R¹ described above. In these cases, at least one of the methyl groups of the compounds D3, D4 and/or D5 may be substituted by at least one of the R¹s.

According to one embodiment, in order to facilitate the recycling of the compounds D3, D4 and D5, as well as their reuse in industrial processes, in particular polymerization processes, these compounds preferably comprise less than 10%, preferably less than 5%, preferably less than 2, and even more preferentially less than 0.2% by weight of the functional groups described by the group R1 as previously discussed above, relative to the total weight of the compounds D3, D4 and D5.

The method of the invention makes it possible preferably to obtain a mass yield of cyclic organopolysiloxanes CO that is greater than 85%, preferably greater than 95% and possibly up to 99% by weight.

Optionally, the compounds D3, D4 and D5 may be separated in particular by distillation, for example by distillation with numerous theoretical plates.

In a particularly advantageous manner, the compounds D3, D4 and D5 obtained by the method of the invention can be used directly in other industrial processes so as to be polymerised and thereby produce novel oils and gums.

The present invention also relates to the use of a catalytic system comprising an alkali salt selected from the salts of K, Na, Rb or Cs, and a multidentate complexing agent, for the depolymerization of organopolysiloxanes O in order to produce cyclic organopolysiloxanes CO.

According to one embodiment, the alkali salt for the above-mentioned use is as defined above.

According to one embodiment, the multidentate complexing agent for the above-mentioned use is as defined above.

Preferably, the multidentate complexing agents used for the depolymerization of organopolysiloxanes O are selected from crown ethers, cryptands which are diamine macroheterocycles and OH- or OCH3-terminated polyethylene glycols (PEGs), preferably OCH₃-terminated polyethylene glycols, preferably the polyethylene glycols are polyethylene glycol dimethyl ethers. Preferably, the PEGs are soluble in the reaction medium. Consequently, and preferably, the PEGs have a low number average molar mass (Mn), for example between 100 and 2000, preferably between 200 and 1000 g/mol.

Preferably, the crown ethers contain from 2 to 8 oxygen atoms. The crown ethers are cyclic oligomers of ethylene oxide comprising as the repeating unit a (CH₂—CH₂—O) group; these crown ethers may be substituted or 2 carbon atoms of a (CH₂—CH₂—O) unit may be fused with a hydrocarbon ring, in particular cyclohexyl or phenyl.

Preferably, the multidentate complexing agents used for the depolymerization of organopolysiloxanes O are selected from:

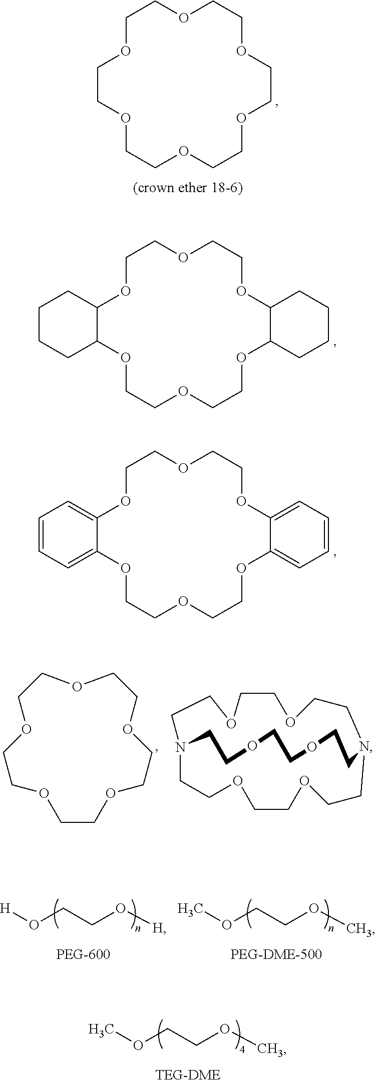

preferably

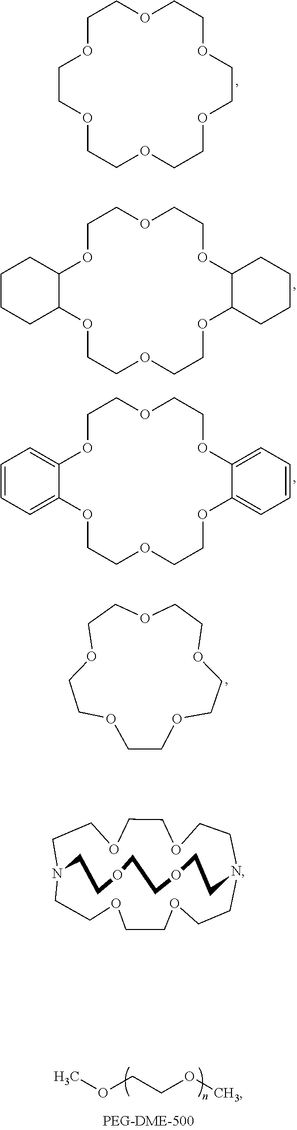

preferably

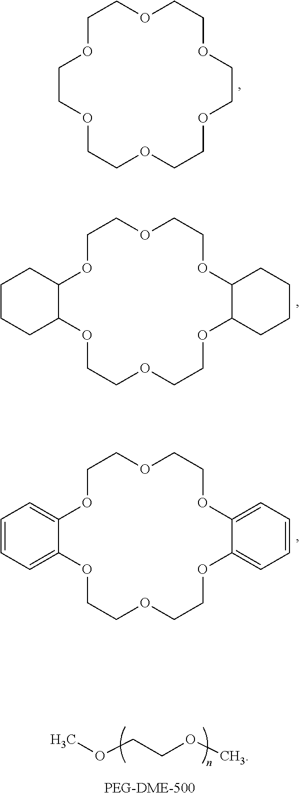

According to one preferred use, the alkali salt used for the depolymerization of organopolysiloxanes O is used in implementation in catalytic proportions, preferably in an amount of between 0.005 and 1.5% by weight relative to the weight of organopolysiloxane (O), preferably between 0.005 and 0.9%, more preferentially between 0.01 and 0.8%.

Preferably, in the context of the above-mentioned use, the alkali salt/multidentate complexing agent molar ratio is between 1/100 and 100/1, preferably between 1/50 and 50/1, more preferably between 1/25 and 25/1, more preferably between 1/10 and 10/1, more preferably between 1/4 and 4/1, preferably between 1/2 and 2/1, preferably greater than or equal to 1, preferably between 1 and 2, for example the ratio is equal to 1.

According to one embodiment, the above-mentioned use is effectively implemented by means of reactive distillation.

The present application will hereinafter be described using the following examples.

### Organopolysiloxanes Deployed in the Examples:

Organopolysiloxane O1:

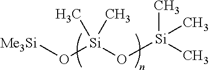

n=70 viscosity 100 mPa·s
Organopolysiloxane O2:

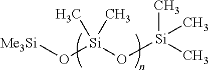

n=100 viscosity 350 mPa·s
Organopolysiloxane O3:

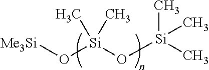

n=100 (waste oil used as a heating bath for a number of years) viscosity 350 mPa·s
Organopolysiloxane O4:

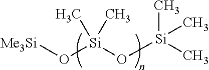

n=180 viscosity 1000 mPa·s
Organopolysiloxane O5:

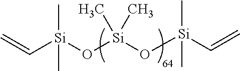

viscosity 100 mPa·s
Organopolysiloxane O6:

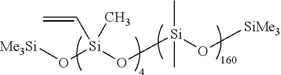

viscosity 450 mPa·s
Organopolysiloxane O7:

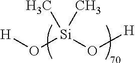

viscosity 100 mPa·s
Organopolysiloxane O8: 50% by weight of O7+50% by weight of 01 the viscosity of the mixture is 100 mPa·s
Organopolysiloxane O9: 50% by weight of O1+50% by weight of silicone gum having the formula

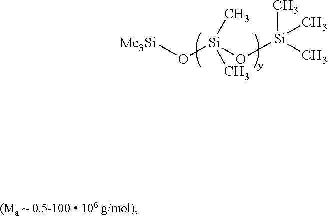

the viscosity of the mixture is less than 60,000 mPa·s
Organopolysiloxane O10:

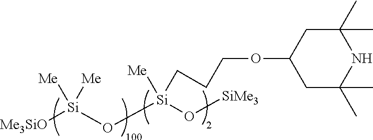

viscosity 250 mPa·s
Organopolysiloxane O11: 50% by weight of O1+50% by weight of PDMS

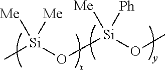

with 5% of Si-Ph units relative to the total number of units and a viscosity of 60,000 mPa·s
Organopolysiloxane O12: 50% by weight of O1+50% by weight of a mixture of 2 organopolysiloxanes of type O5 but with a number of different units, one with a viscosity of 10,000 mPa·s and the other with a viscosity of 60,000 mPa·s, and a crosslinking catalyst.
Organopolysiloxane O13: 50% by weight of O1+50% by weight of a mixture of 2 organopolysiloxanes of type O5 but with a number of different units, one with a viscosity of 10,000 mPas·s and the other with a viscosity of 60,000 mPas·s, and approximately 5% by weight of a silicone oil comprising Si—H units.
Organopolysiloxane O14:O1+crosslinked silicone gel derived from crosslinking between O12 and O13 free of fillers.

### Alkali Salts Deployed in Implementation in the Examples:

SA1: KOSiMe₃
SA2: KOSiMe₂Vi
SA3: KOH
SA4: KO-tBu
SA5: RbOSiMe₃
SA6: CsOSiMe₃
SA7:

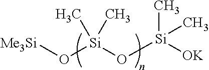

with n=between 1 and 10
SA8: CsOH

### Multidentate Complexing Agent Deployed in Implementation in the Examples:

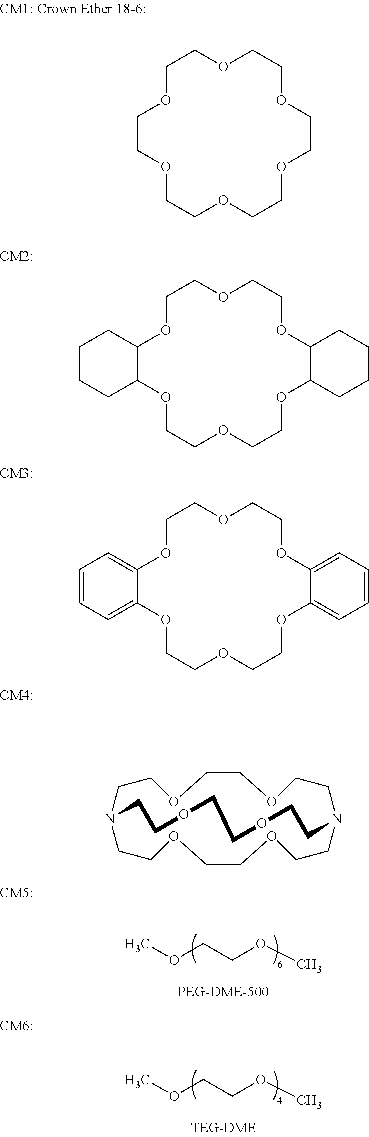

### Example 1: General Protocol in Batch (Discontinuous) Mode

In a flask (50 mL) topped with a vigorous column, the organopolysiloxane, alkali salt and multidentate complexing agent are introduced and heated at temperature T for a period of 30 minutes to 1 hour. The reaction mixture is then distilled under reduced pressure for a period of 20-25 minutes.

In the results reported in the tables of the examples:
the cyclosiloxane yield was determined by the mass ratio between the mass of the distilled products and the mass of the starting organosiloxane O; and
the D3/D4/D5/other ratio was determined between the integrated intensity of the signals (D3/D4/D5/other) in the 29Si-NMR spectrum; this ratio corresponds to a ratio by weight.

### Example 2: Impact of Temperature and Pressure

The protocol described in Example 1 is implemented with KOSiMe₃ (SA1) being used as the alkali salt and a crown ether 18-6 (CM1). The reaction mixture is heated for a period of 30 minutes prior to reactive distillation (temperature and pressure as mentioned above).

The organopolysiloxane used is organopolysiloxane O1.

The results are compiled in Table 1 below

TABLE 1

| Temperature, | | | m | | D3/D4/D5/ |
|---|---|---|---|---|---|
| Pressure, Time | m O1 | m Alkali | Complexing | Yield of OC | Other |
| (Distillation) | (g) | Salt (mg) | Agent (mg) | (%) | Ratio* |
| 170° C., 35 mbar, 20 | 9.5 | 15 | 30 | 96 | 8/76/14/2 |
| min | | | | | |
| 140° C., 10 mbar, 25 | 9.5 | 15 | 30 | 96 | 8/83/8/1 |
| min | | | | | |
| 110° C., 0.1 mbar, | 9.5 | 15 | 30 | 94 | 2/66/28/4 |
| 15 min | | | | | |
| 90° C., 0.1 mbar, 20 | 9.5 | 15 | 30 | 94 | 2/68/28/2 |
| min | | | | | |
| 70° C., 0.1 mbar, 22 | 9.5 | 15 | 30 | 95 | 2/74/22/2 |
| min | | | | | |
| 60° C., 0.1 mbar, 25 | 9.5 | 15 | 30 | 91 | 2/68/27/3 |
| min | | | | | |

*Other = (Me₃Si)₂O + D6

These results show that the method of the invention effectively enables depolymerization and formation of cyclic organopolysiloxane, with the method in particular exhibiting selectivity for the compounds D4. In an advantageous manner, the method of the invention requires a small amount of catalyst.

### Example 3: Impact of the Anion X of the Alkali Salt

The protocol described in Example 1 is implemented with KX being used as the alkali salt, and a crown ether 18-6 (CM1). The reaction mixture is heated for a period of 1 h prior to reactive distillation at a temperature of 140° C. and a pressure of 10 mbar for a period of 20-25 min.

The organopolysiloxane is O1.

The results are compiled in Table 2 below.

TABLE 2

| | m O1 | m Alkali | m CM1 | Yield of OC | D3/D4/D5/Other |
|---|---|---|---|---|---|
| Alkali Salt | (g) | Salt (mg) | (mg) | (%) | Ratio* |
| SA1 | 9.5 | 15 | 30 | 96 | 8/83/8/1 |
| SA2 | 9.5 | 17 | 30 | 97 | 6/80/11/3 |
| SA3 | 9.5 | 7 | 30 | 95 | 7/78/14/1 |
| SA4 | 9.5 | 13 | 30 | 97 | 5/78/14/3 |
| SA5 | 9.5 | 20 | 29 | 95 | 6/79/12/3 |
| SA6 | 9.5 | 25 | 30 | 95 | 5/77/15/3 |
| SA7 | 9.5 | 42 | 31 | 92 | 7/78/12/3 |
| SA8 | 9.5 | 20 | 30 | 97 | 5/76/17/2 |

*Other = (Me3Si)_{2O} + D6

These results show that the method of the invention may be implemented with different alkali salts while at the same time maintaining the selectivity for D4 production.

### Example 4: Impact of the Multidentate Complexing Agent

The protocol described in Example 1 is implemented with KOSiMe₃ (SA1) being used as the alkali salt, and a multidentate complexing agent. The reaction mixture is heated for a period of 1 h prior to reactive distillation at a temperature of 140° C. and a pressure of 10 mbar for a period of 20-25 min.

The organopolysiloxane is O1.

The results are compiled in Table 3 below.

TABLE 3

| | | | m | | D3/D4/D5/ |
|---|---|---|---|---|---|
| Multidental | | m SA1 | Complexing | Yield of OC | Other |
| Complexing Agent | m O1 (g) | (mg) | Agent (mg) | (%) | Ratio* |
| CM1 | 9.5 | 15 | 30 | 96 | 8/83/8/1 |
| CM2 | 9.5 | 15 | 45 | 96 | 5/76/17/2 |
| CM3 | 9.5 | 14.5 | 43 | 92 | 7/80/10/3 |
| CM4 | 9.5 | 15 | 46 | 92 | 8/78/10/4 |
| CM5 | 9.5 | 15 | 62 | 94 | 11/78/7/4 |
| CM6 | 9.5 | 15 | 28 | 57 | 10/80/10/0 |

These results show that the method of the invention may be implemented with different complexing agents with good yields.

### Example 5: Impact of Organopolysiloxane

The protocol described in Example 1 is implemented with KOSiMe₃ (SA1) being used as the alkali salt and a crown ether 18-6 (CM1). The reaction mixture is heated for a period of 1 hour prior to reactive distillation, at a temperature of 140° C. and a pressure of 10 mbar for a period of 20-25 min.

The results are compiled in Table 4 below.

TABLE 4

| | | | m CM1 | Yield of OC | D3/D4/D5/Other |
|---|---|---|---|---|---|
| Or | m O(g) | m SA1 (mg) | (mg) | (%) | Ratio* |
| O1 | 100 | 142 | 264 | 99 | 7/82/8/3 |
| O2 | 9.5 | 15 | 30 | 97 | 7/81/11/1 |
| O3 | 100 | 150 | 280 | 99 | 7/81/11/1 |
| O4 | 9.5 | 15 | 30 | 95 | 9/80/10/1 |
| O5 | 9.5 | 14 | 26 | 94 | 8/80/10/2 |
| O6 | 9.5 | 14 | 26 | 93 | nd |
| O7 | 9.5 | 16 | 26 | 75 | 10/82/8/0 |
| O8 | 6.7 g of O7 + 2.8 g of O1 | 14 | 26 | 98 | 4/82/14/0 |
| O9 | 5 g silicone gum + 5 g O1 | 16 | 30 | 96 | 7/78/13/1 |
| O10 | 9.5 | 16 | 30 | 68 | 7/78/14/1 |
| O11 | 4.9 g PDMS + 5 g O1 | 70 | 130 | 79 | 8/77/13/2 |
| O12 | 5.6 g of the mixture of | 70 | 130 | 97 | 7/82/11/0 |
| | organopolysiloxane type | | | | |
| | O5 + 5.6 g O1 | | | | |
| O13 | 5.1 g of the mixture of | 70 | 130 | 96 | 10/80/10/0 |
| | organopolysiloxane type | | | | |
| | O5 and Si—H oil + 5.3 g O1 | | | | |
| O14 | 3 g cross-linked silicone | 70 | 130 | 95 | 8/79/11/2 |
| | gel + 9.0 g O1 | | | | |

*Other = (Me3Si)₂O + D6

The results show that the method of the invention makes it possible to process a variety of organopolysiloxanes while at the same time achieving good yields and a high degree of selectivity, particularly for D4. The examples also show that the method of the Invention makes it possible to process waste (used) silicone oils, gums and cross-linked silicone gels.

### Example 6: Impact of the Alkali Salt/Multidentate Complexing Agent Ratio

The protocol described in Example 1 is implemented with different catalyst/catalytic systems, at a temperature of 140° C. The reaction mixture is heated for a period of 30 minutes prior to reactive distillation at a temperature of 140° C. and a pressure of 10 mbar for a period of 20-25 min.

The organopolysiloxane is O1.

The results are compiled in Table 5 below.

TABLE 5

| | | m SA1 | | |
|---|---|---|---|---|
| Catalytic System | m O1 (g) | (mg) | m CM1 (mg) | OC Yield (%) |
| SA1 + CM1 | 9.5 | 15 | 30 | 96 |
| SA1 + CM1 | 9.5 | 14 | 60 | 95 |
| SA1 + CM1 | 9.5 | 14 | 120 | 95 |
| SA1 + CM1 | 9.5 | 14 | 15 | 94 |
| SA1 + CM1 | 9.5 | 14 | 8 | 95 |
| SA1 + CM1 | 19 | 7 | 14 | 96 |
| SA1 + CM1 | 28.5 | 4 | 8 | 97 |
| SA1 (Comparative) | 9.5 | 14 | 0 | 15 |
| CM1 (Comparative) | 9.5 | 0 | 30 | 0 |
| KOH (2.95% by weight of | 9.5 | 280 | 0 | 16 |
| O1) (condition of US5670689) Comparative | | | | |

These results show that the catalytic system of the invention makes it possible to obtain a very high yield of cyclo siloxane.

### Example 7: Example with an Oil Derived from a Chlorosilane Hydrolysis Reaction by-Product

The protocol described in Example 1 is implemented with different catalytic systems. The reaction mixture is heated to 150° C. for a period of 30 minutes prior to reactive distillation at a temperature of 150° C. and a pressure of 5 mbar for a period of 30 minutes.

The organopolysiloxane is an oil derived from chlorosilane hydrolysis reaction by-products comprising at least 95% of an organopolysiloxane which comprises approximately 2% of the group Si—H, and other reaction products such as residues of the reaction product, the catalyst, etc.

The results are compiled in Table 6 below.

TABLE 6

| | | | m Alkali | m | |
|---|---|---|---|---|---|
| Catalytic | | | Salt | Complexing | |
| System | Solvent | m O (g) | (mg) | Agent (mg) | OC Yield (%) |
| SA1 + CM1 | C₁₈H₃₇—OH (10% by | 9.5 | 70 | 130 | 75 |
| | weight relative to the | | | | |
| | weight of O) | | | | |
| SA1 + CM5 | | 9.5 | 70 | 1000 | 75 |
| SA1 | | 9.5 | 70 | 0 | 0 |
| (Comparative) | | | | | |
| SA3 | | 9.5 | 31 | 0 | 0 |
| (Comparative) | | | | | |

These results show that the catalytic system of the invention makes it possible to obtain cyclosiloxane with oils derived from industrially generated by-products and therefore of complex composition.

1. A method for preparing cyclic organopolysiloxane CO by reactive distillation of at least one organopolysiloxane O in the presence of an alkali salt type catalyst selected from the salts of K, Na, Rb or Cs, and of a multidentate complexing agent.

2. A method according to claim 1, wherein the organopolysiloxane O is selected from linear organopolysiloxanes, for example oils, or gums, or branched organopolysiloxanes.

3. A method according to claim 1, wherein the organopolysiloxane O comprises:
at least 5 units, having the formula R_{c}SiO_{(4-c)/2} wherein
R, which may be identical or different, represents
an alkyl group containing from 1 to 15 carbon atoms
an aryl group containing from 6 to 10 carbon atoms, and c=0, 1, 2 or 3; and
possibly one or more units having the formula R¹_{d}RₑSiO_{(4-d-e)/2}
wherein:
R is as defined above
R¹, which may be identical or different, represents:
an alkenyl group containing from 2 to 6 carbon atoms;
a hydroxyl group (OH);
a group (O-Alk) with Alk representing an alkyl group containing from 1 to 15 carbon atoms
a group (O-Alk) x with Alk representing an alkyl group containing from 1 to 15 carbon atoms; and
x represents an integer between 2 and 200;
an amino group selected from (Alk)-NH₂ or (Alk)-NH—(Alk)-NH₂, with Alk representing an alkyl containing from 1 to 5 carbon atoms;
cyclic amine 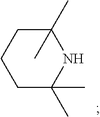
a hydrogen;
d=1, 2 or 3; e=0, 1 or 2; and the sum d+e=1, 2 or 3.

4. A method according to claim 1, wherein at least one oganopolysiloxane O satisfies formula (I):
R¹ₐR₍₃₋ₐ₎SiO—(SiR₂O)ₙ—(SiR¹RO)ₘ—SiR¹ₐR₍₃₋ₐ₎ (I)
wherein:
R which may be identical or different, represents:
an alkyl group containing from 1 to 15 carbon atoms;
an aryl group containing from 6 to 10 carbon atoms; R¹, which may be identical or different, represents:
an alkenyl group containing from 2 to 6 carbon atoms;
a hydroxyl group (OH);
a group (O-Alk) with Alk representing an alkyl group containing from 1 to 15 carbon atoms;
a group (O-Alk), with Alk representing an alkyl group containing from 1 to 15 carbon atoms; and x represents an integer between 2 and 200;
an amino group selected from (Alk)-NH₂ or (Alk)-NH—(Alk)-NH₂, with Alk representing an alkyl containing from 1 to 5 carbon atoms;
cyclic 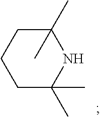
a hydrogen;
a is an integer and represents 0, 1, 2 or 3;
n represents an integer between 10 and 10,000;
m represents an integer between 0 and 100.

5. A method according to claim 1, wherein the alkali salt is selected from alkali silanolates, alkali hydroxides, alkali alkoxides, and alkali siliconates.

6. A method according to claim 1, wherein the alkali salt is a salt of potassium.

7. A method according to claim 1, wherein the multidentate complexing agent is selected from crown ethers, cryptands which are diamine macroheterocycles, and OH- or OCH₃-terminated polyethylene glycols.

8. A method according to claim 1, wherein the multidentate complexing agent is selected from crown ethers, and OCH₃-terminated polyethylene glycols having a weight average molar mass between 100 and 2000 g/mol.

9. A method according to claim 1 wherein the reactive distillation is implemented at a temperature of between 5° and 200° C.

10. A method according to claim 1 wherein the amount of alkali salt used is between 0.005 and 1.5% by weight relative to the weight of organopolysiloxane (O).

11. A method according to claim 1, wherein a mixture of cyclic organopolysiloxanes CO is obtained that comprises more than 95% by weight of a mixture of the compounds D3, D4 or D5, relative to the total weight of cyclic organopolysiloxanes CO produced

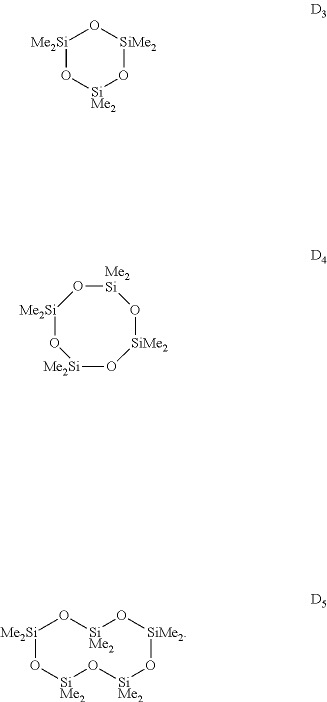

12. A method according to claim 1, wherein the multidentate ligand is selected from:

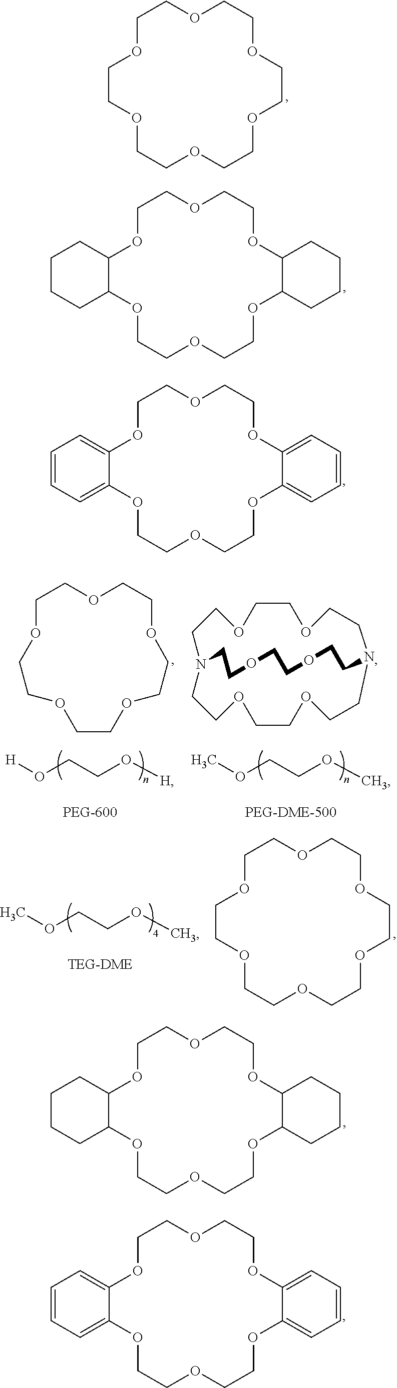

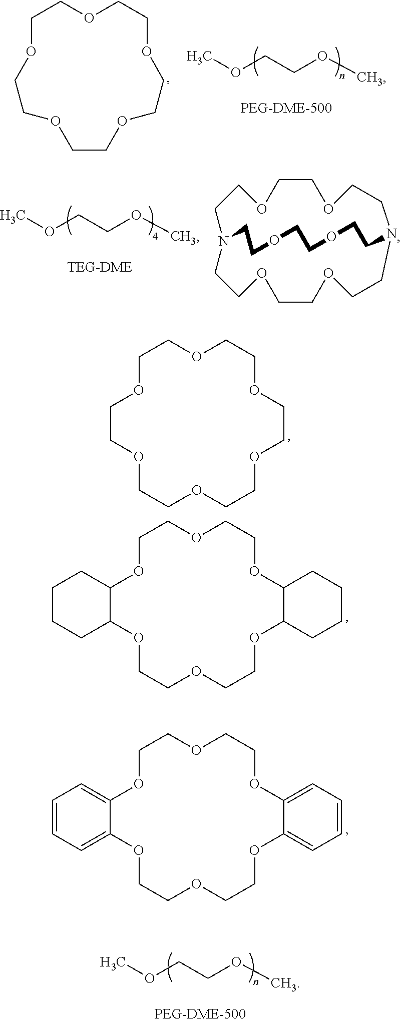

13. A method according to claim 1, wherein the mass yield of cyclic organopolysiloxane CO is greater than 85%.

14. A method for the depolymerisation of organopolysiloxanes; O comprising a step of contacting said organopolysiloxane with a catalytic system comprising an alkali salt selected from the salts of K, Na, Rb or Cs, and a multidentate complexing agent.

15. The method according to claim 14, wherein the alkali salt is selected from alkali silanolates, alkali hydroxides, alkali alkoxies, and alkali siliconates and/or the multidentate complexing agent is selected from crown ethers, cryptands which are diamine macroheterocycles, and OH- or OCH₃-terminated polyethylene glycols.
